(19) United States
(12) Patent Application Publication
(10) Pub. No.: US 2008/0247757 A1
(43) Pub. Date: Oct. 9, 2008

(54) METHOD OF CONTROLLING DEVICE BY USING UNIVERSAL REMOTE CONTROL

(75) Inventors: Chang Gun Um, Daegu Metropolitan City (KR); Seung Mun Rho, Daegu Metropolitan City (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/049,601

(22) Filed: Mar. 17, 2008

(30) Foreign Application Priority Data
Apr. 3, 2007 (KR) 10-2007-0032792

(51) Int. Cl. H04B 10/00; H04L 17/02

(52) U.S. Cl. 398/106; 341/176

(57) ABSTRACT

A method of controlling a device with a universal remote control includes obtaining and storing an image of an operation panel of a remote control that controls the device, assigning a control command received to control the device to an input key area contained in the image, storing the input key area and the assigned control command, displaying the image of the operation panel of the remote control, and outputting the assigned control command in response to a touch signal is input to the input key area.

### CROSS REFERENCE TO RELATED APPLICATION

This application claims priority from and the benefit of Korean Patent Application No. 10-2007-0032792, filed on Apr. 3, 2007, which is hereby incorporated herein by reference for all purposes as if fully set forth herein.

### BACKGROUND OF THE INVENTION

1. Field of the Invention

The present invention relates to a method of controlling a device with a universal remote control, and more particularly, to a method of registering a device with a universal remote control and controlling the registered device.

2. Discussion of the Background

Recently, the popularity of remotely controlling electronic devices has increased and therefore, the number of remote controls being used at home has also increased. Because the number of remote controls has increased, the selection of a proper remote control and the management of remote controls may be complicated. Therefore, universal remote controls, which integrate various remote control functions, have been developed. A universal remote control stores a control program that may enable a plurality of devices to be controlled by the universal remote control. If one of these devices is selected, the universal remote control outputs a control signal to control the selected device. However, with a conventional universal remote control, only input keys installed in the universal remote control may be used. For example, a command not assigned to any input key of the universal remote control may not be generated and hence may not be used to control a corresponding device.

### SUMMARY OF THE INVENTION

The present invention provides a method of registering a device with a universal remote control and controlling the registered device.

Additional features of the invention will be set forth in the description which follows, and in part will be apparent from the description, or may be learned by practice of the invention.

The present invention discloses a method of controlling a device with a universal remote control including obtaining and storing an image of an operation panel of a remote control that controls the device, assigning a control command received to control the device to an input key area contained in the image, storing the input key area and the assigned control command, displaying the image of the operation panel of the remote control, and outputting the assigned control command in response to a touch signal input to the input key area.

The present invention also discloses a universal remote control including an image input unit, an infrared unit, a control unit, a user interface unit, and a storage unit. The image input unit obtains an image of an operation panel of a remote control that controls a device and the infrared unit transmits and receives a control command using infrared rays. The control unit assigns a control command received to control the device to an input key area contained in the image and outputs the control command in response to a touch signal input at the input key area. The user interface unit detects the touch signal and displays a screen image corresponding to the signal and includes a display unit and a touch sensor. The storage unit stores the image of the operation panel, the input key area, and the assigned control command.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a universal remote control according to an exemplary embodiment of the present invention.

FIG. 2 is a flow chart showing a method of controlling a device with a universal remote control according to another exemplary embodiment of the present invention.

FIG. 3 is a flow chart showing a process of registering a device control command when a device registration mode is selected in the method of FIG. 2.

FIG. 4 is a flow chart showing a process of outputting a device control command when a device control mode is selected in the method of FIG. 2.

FIG. 5 is a view showing an example of an operation panel of a universal remote control according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different form and should not be construed as limited to the embodiments set forth herein. Rather, these embodiments are provided so that this disclosure is thorough, and will fully convey the scope of the invention to those skilled in the art. Like reference numerals in the drawings denote like elements.

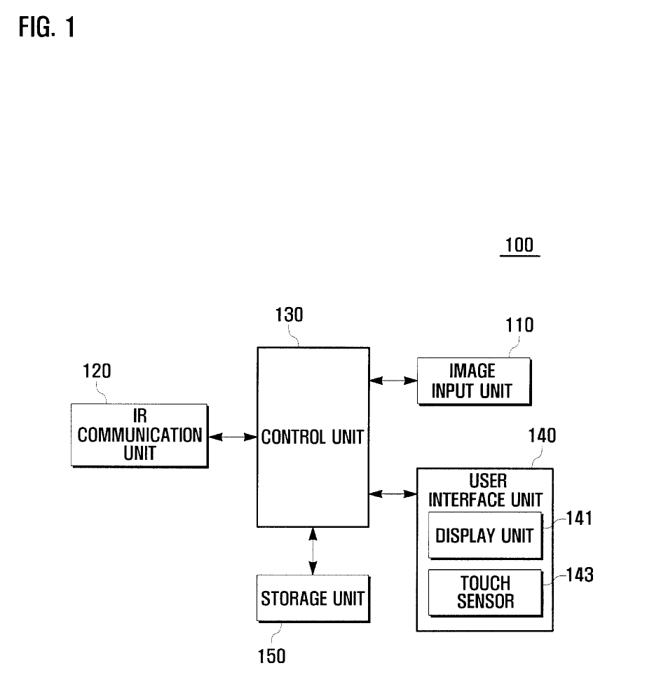

FIG. 1 is a block diagram showing a configuration of a universal remote control according to an exemplary embodiment of the present invention.

Referring to FIG. 1, an image input unit 110 obtains an image from an external source. In particular, the image input unit 110 obtains an image of an operation panel of a remote control controlling a specific device. A control unit 130 controls a storage unit 150 to save the image obtained by the image input unit 110.

For example, when the image input unit 110 includes a camera, the image input unit 110 may obtain an image of an operation panel of a remote control for a specific device by taking a picture of the operation panel. Alternatively, when the image input unit 110 includes a scanner, the image input unit 110 may obtain an image of an operation panel of a remote control for a specific device by scanning a photograph or a picture of the operation panel.

An infrared (IR) communication unit 120 transmits and receives a control command using infrared rays. The IR communication unit 120 receives a control command output by another remote control and outputs a control command for a device.

The control unit 130 controls general operation of the universal remote control 100. The control unit 130 controls operations for registering a device with the universal remote control 100 and controlling the registered device. To register a device with the universal remote control 100, the control unit 130 analyzes an image obtained by the image input unit 110 and identifies an input key area from the analyzed image. For example, the control unit 130 identifies a character included in the image. The character may be a Korean letter, an English letter, a number, or a special character (for example, [symbol] [symbol] ▾, and ⊚). Additionally, the control unit 130 detects a boundary of an input key included in the image. The control unit 130 calculates differences of color (RGB) values between individual pixels of the image and identifies adjacent pixels of the image that have a large color difference as defining a boundary of an input key. The control unit 130 identifies an area within the boundaries as an input key area and regards the input key area as an object.

A user interface unit 140 detects a user input signal and displays a screen image corresponding to the detected user input signal. The user interface unit 140 is configured with a touch screen and includes a display unit 141 to display an operation panel of a remote control and a touch sensor 143 to detect a selection signal input to the displayed operation panel.

The display unit 141 may include a liquid crystal display (LCD) controller, memory to store display data, and an LCD device. The control unit 130 controls the display unit 141 to display an image of an operation panel corresponding to a specific device, which was obtained by the image input unit 110. The display unit 141 displays an image including input key areas, which represent individual objects. If a specific input key area is selected by generating a touch signal, the display unit 141 displays the selected input key area in a color different from those of unselected input key areas.

The touch sensor 143 is installed in the display unit 141 and detects a touch signal input to the display unit 141 by a user. If a touch signal is generated, the touch sensor 143 identifies the touch signal by detecting changes in physical properties, such as resistance and capacitance.

The storage unit 150 includes a program memory and a data memory. The program memory stores a program to operate a remote control, a program to recognize a character included in an image, and a program to detect a boundary of an input key included in the image. The data memory stores data generated during execution of the programs. For example, the data memory may store an input key area identified by the control unit 130 and a control command to control the corresponding device by assigning the control command to the input key area. In another example, the data memory may store a character included in an image and a control command to control the corresponding device by assigning the control command to the character. The character may be a Korean letter, an English letter, a number, or a special character (for example, [symbol] [symbol] ▾, and ⊚). The storage unit 150 may store the identified characters and control commands in the form shown in Table 1.

TABLE 1

| Character | Control command |
|---|---|
| [symbol] | Replay audio/video |
| ⊚ | Record audio/video |
| ▾ | Reduce sound volume |

For example, the storage unit 150 stores a character [symbol] and a control command ‘Replay audio/video’ in a record form.

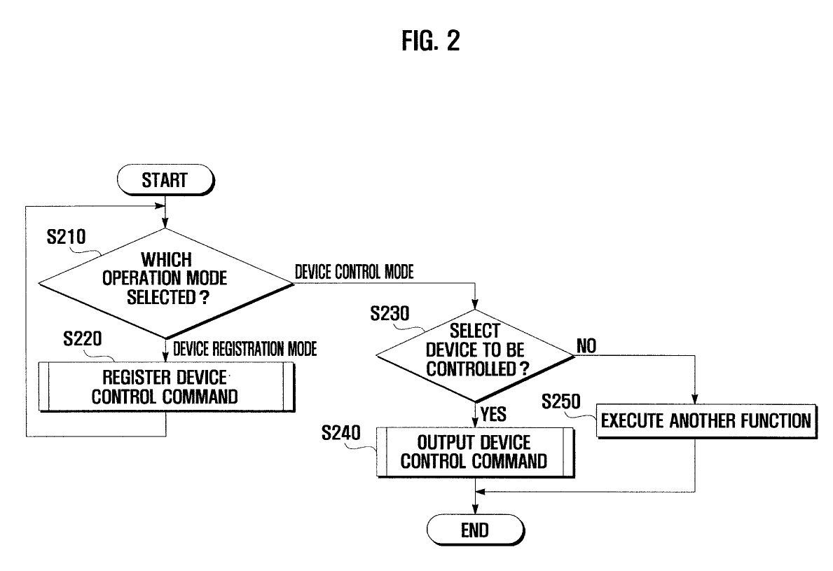

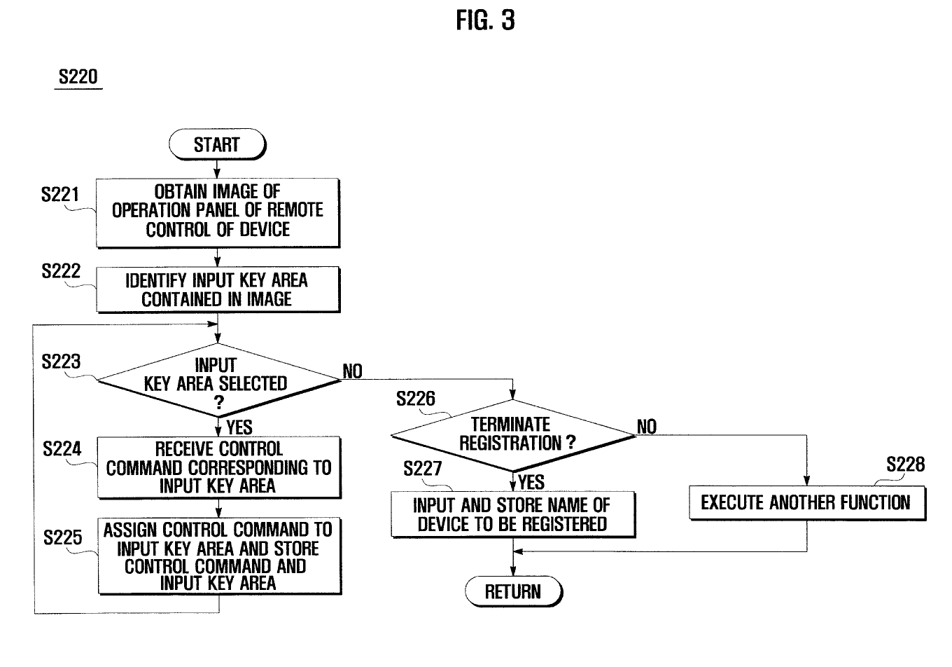

Referring to FIG. 1 and FIG. 2, the control unit 130 determines which operation mode has been selected according to a user's selection signal, which may be input through the user interface unit 140 (S210). Here, the selection signal may be a touch signal. If the selected operation mode is a device registration mode, the control unit 130 registers a control command of the corresponding device with the universal remote control 100 (S220). A detailed process of registering a control command to the universal remote control 100 is described referring to FIG. 3.

Referring to FIG. 1 and FIG. 3, the control unit 130 receives an image of an operation panel of a remote control of a device to be registered from the image input unit 110 (S221). If the image input unit 110 includes a camera, the control unit 130 may control the image input unit 110 to obtain an image by taking a picture of the operation panel of the remote control of the device. If the image input unit 110 includes a scanner, the control unit 130 may control the image input unit 110 to obtain an image by scanning an existing photograph or picture of an operation panel of the remote control of the device. Further, control unit 130 may obtain an image by downloading a photograph of an operation panel of a remote control of a device from an external storage medium and storing the obtained image of the operation panel in the storage unit 150.

After obtaining the image of the operation panel, the control unit 130 identifies an input key area included in the obtained image by analyzing the image (S222). For example, the control unit 130 identifies a character included in the image. The character may be a Korean letter, an English letter, a number, or a special character (for example, [symbol] [symbol] ▾, and ⊚). Additionally, the control unit 130 detects a boundary of an input key included in the image. The control unit 130 calculates differences of color (RGB) values between individual pixels of the image and identifies adjacent pixels of the image that have a large color difference as defining a boundary of an input key. The control unit 130 identifies an area within the boundaries as an input key area and regards the input key area as an object.

After identifying an image, the control unit 130 determines whether a touch signal is input to the input key area (S223). If a touch signal is input to the input key area, the control unit 130 controls the IR communication unit 120 to receive a control command to be assigned to the touched input key area (S224). For example, if a touch signal is input to an input key ‘4’ among input keys displayed in the display unit 141 of the user interface unit 140, the control unit 130 enters an IR reception mode to receive a control command corresponding to the input key ‘4’. The control unit 130 controls the IR communication unit 120 to receive an IR signal including the control command from the remote control being used for the device to be registered.

When the control command corresponding to the selected input key area is received, the control unit 130 assigns the received control command to the input key area selected at step S223, and stores the control command and the selected input key area in a table form in the storage unit 150 (S225). Subsequently, the control unit 130 returns to step S223 and identifies whether a touch signal has been input at an identified input key area. If no touch signal has been input at the input key area, the control unit 130 determines whether a signal to terminate the registration of a device control command has been input (S226). If a signal to terminate the registration of a device control command has been input, the control unit 130 registers the universal remote control 100 and stores the device by adding its name to the information stored at step S225 (S227).

If no signal to terminate the registration of a device control command is input at step S226, the control unit 130 executes another function (S228).

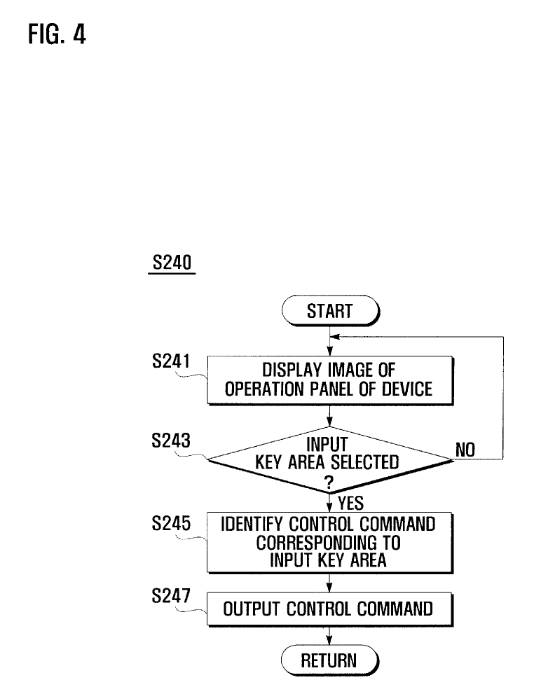

Returning to FIG. 2, if the selected operation mode of the universal remote control 100 is a device control mode at step S210, the control unit 130 determines whether a device to be controlled has been selected (S230). If a plurality of devices is registered, the control unit 130 controls the display unit 141 to display a list of devices that may be controlled and selects a specific device according to the user's touch signal. The control unit 130 then outputs a control command corresponding to the selected device by detecting a further touch signal input by the user (S240). A detailed process of outputting a control command corresponding to the selected device is described referring to FIG. 4.

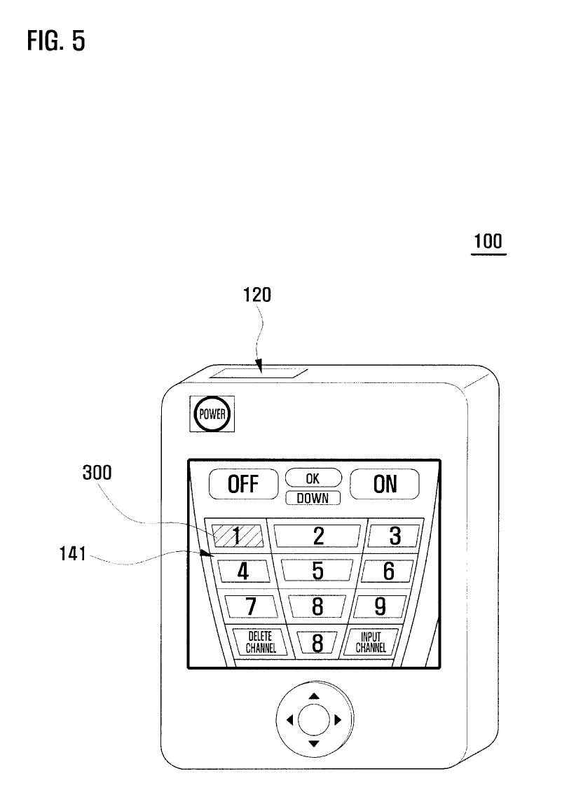

Referring to FIG. 1 and FIG. 4, the control unit 130 controls the display unit 141 to display an image corresponding to the operation panel of the device registered at step S220 (S241). Subsequently, the control unit 130identifies whether an input key area has been selected by the input of a touch signal at the input key area (S243). If an input key area has been selected, the control unit 130 identifies a control command corresponding to the selected input key area (S245). The control unit 130 then controls the IR communication unit 120 to output an IR signal including the identified control command from the universal remote control 100 (S247). For example, the control unit 130 may control the display unit 141 to display an image corresponding to an operation panel of the registered device, as shown in FIG. 5. When an input key area 300 indicating character ‘1’ is selected by a user's touch signal, the selected input key area 300 is displayed in a different color from those of other input key areas.

According to exemplary embodiments of the present invention, various operation panels are provided for corresponding devices, which may allow a user to utilize all control functions of the devices conveniently. Further, a user-oriented universal remote control is provided that may select a correct operation panel corresponding to a selected device, because images of each operation panel are provided in various forms.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of controlling a device with a universal remote control, comprising:
obtaining and storing an image of an operation panel of a remote control that controls the device;
assigning a control command received to control the device to an input key area contained in the image;
storing the input key area and the assigned control command;
displaying the image of the operation panel of the remote control; and
outputting the assigned control command in response to a touch signal input at the input key area.

2. The method of claim 1, wherein assigning a control command to an input key area comprises:
identifying an input key area from the obtained image by analyzing the image; and
receiving the control command corresponding to the input key area to control the device in response to a touch signal input at the input key area.

3. The method of claim 2, wherein identifying an input key area from the obtained image comprises identifying a character contained in the image.

4. The method of claim 2, wherein identifying an input key area from the obtained image comprises detecting a boundary of an input key contained in the image.

5. The method of claim 1, wherein outputting the assigned control commend in response to a touch signal at the input key area comprising, displaying the selected input key area and an unselected input key area in different colors after outputting a control command assigned to the input key area at which a touch signal is input.

6. The method of claim 1, wherein the image of an operation panel is received from an external source.

7. The method of claim 1, wherein the image of an operation panel is obtained from a camera of the universal remote control.

8. A universal remote control, comprising:
an image input unit to obtain an image of an operation panel of a remote control that controls a device;
an infrared unit to transmit and receive a control command using infrared rays;
a control unit to assign a control command received to control the device to an input key area contained in the image and to output the control command in response to a touch signal input at the input key area;
a user interface unit to detect the touch signal and display a screen image corresponding to the signal, the user interface unit comprising a display unit and a touch sensor; and
a storage unit to store the image of the operation panel, the input key area, and the assigned control command.

9. The universal remote control of claim 8, wherein the image input unit comprises a camera.

10. The universal remote control of claim 8, wherein the image input unit comprises a scanner.
